(19) United States
(12) Patent Application Publication
(10) Pub. No.: US 2010/0242095 A1
(43) Pub. Date: Sep. 23, 2010

(54) METHOD AND APPARATUS FOR MULTI-USER, MULTI-APPLICATION INTERNET ACCESS AUTHENTICATION AND CONTROL

(75) Inventor: DAVID Charles MENDENHALL, North Bay Village, FL (US)

Correspondence Address: David Mendenhall;GigaNetworks, Inc, 7510 Miami View Dr, North Bay Village, FL, 33141, US

(73) Assignee: GigaNetworks, Inc., Miami, FL (US)

(21) Appl. No.: 12/407,852

(22) Filed: Mar. 20, 2009

(51) Int. Cl. H04L 9/32; G06F 15/16

(52) U.S. Cl. 726/4; 709/203; 726/12; 726/11

(57) ABSTRACT

Methods, system, computer program products and data structures are described to allow a client to be identified using a plurality of methods during the process of accessing Internet resources through a Proxy or Firewall device. The resultant plurality of methods combines to result in a specific user identification process via multiple data stores. These independent data stores are then quarried to identify a user via a network access process that would not commonly respond to a specific authentication process. A single aggregate data store of user identification information is created to facilitate a more effective search process.

### CITATIONS

U.S. Pat. No. 7,269,659 Issue date: Sep. 11, 2007
U.S. Pat. No. 7,382,881 Issue date: Jun. 3, 2008
U.S. Pat. No. 6,839,761 Issue date: Jan. 4, 2005
U.S. Pat. No. 6,112,228 Issue date: Aug. 29, 2000
U.S. Pat. No. 6,959,336 Issue date: Oct. 25, 2005
U.S. Pat. No. 7,389,540 Issue date: Jun. 17, 2008
U.S. Pat. No. 6,023,698 Issue date: Feb. 8, 2000
U.S. Pat. No. 5,805,803 Issue date: Sep. 8, 1998

### BACKGROUND OF THE INVENTION

This invention relates to the use of Firewall and Proxy technology, heretofore Internet Control Device, to intercept a Client-Server computer transaction and associate the physical person, heretofore User, identification information stored in an LDAP or RADIUS server system, such as Microsoft Active Directory, to control access to various Internet Application resources.

The Internet includes many different servers and clients. But to operate each Client needs to access an Application Resource on a specific Server. Within the terminology of servers, Internet Control Devices are devices that intercept transactions and allow or disallow a transaction to continue based on a Policy. This control architecture is fundamental when it comes to the wide-spread and widely variable content that exists on the Internet.

Effectively controlling access in today's environments when IP addresses are delivered to Client systems without respect to the User identification, detailed information needs to be extracted and coordinated between the Internet Application resource, the Client computing environment and the User. Many environments use a RADIUS, LDAP or Microsoft® Active Directory process to authenticate Users onto the network. As used herein, the Authentication Method will relate to any process of defining an individual User to a Client, including virtual Clients, and to a specific Internet Application resource. As used herein, the Authentication Data Store will contain a list of users and the associated client systems with the result that a User's Client-to-Internet Application resource request can be controlled by policy.

Extraction of the User identity from an initial Client to Internet Application resource transaction within the Web Server environment, such as a request to www.google.com, uses a well-known Authentication request process called WWW-Authenticate Response Header and the replies back to the initiating Client system requesting User identity data. The User identification data is released from the Client via the HTTP Digest access authentication, IETF RFC 2069, process. This process commonly occurs transparently to the User when the Internet Control Device requesting the information is 1) trusted by the Client, and 2) when the application knows how to respond to the request.

This invention creates a method of determining User identification when a Client request to an Internet Application resource does not have a standardized method for responding to well-known Authentication processes.

### SUMMARY OF THE INVENTION

This invention solves a problem that occurs when an Internet Application does not have the capability to respond to a standard Authentication request. Applications such as Instant Messaging, peer-to-peer traffic, streaming media services and Microsoft® Outlook commonly ignore a WWW-Authenticate Response transaction. A new method to identify a User that transparently covers both a response to the Standard Authentication and to the lack of a response was needed.

The art described is a process to use various identification methods to populate a number of different Application Data Stores each containing a database of specific User identification information associated with the originating Client computer identification, and the associated Internet Application resource.

Each Application Data Store associates an Internet Application resource, eg Peer-to-Peer and Instant Messaging are two different Internet Application types, and an associated Authentication method connected to a list of Users requesting access to that specific Internet Application resource. Unique Application Data Stores are created when differing Application Authentication Methods are required. Each Application Data Store associates a unique Authentication method to a specific User and Client system.

Each Application Data Store contains an optional Internet Application resource time-to-live value. The value is reset to a starting point when the Internet Application is accessed by the User from the Client. When the time-to-live value expires, the Users credential information and Client system information are purged from the database. This process effectively logs the Client out of that specific Internet Resource application.

An Access Data Store is used to aggregate the contents of the different Application Data Stores. The Access Data Store, in certain environments such as a Microsoft Active Directory infrastructure, has the ability to monitor Active Directory log-in and log-out events. This function allows the Access Data Store to create an entry without an associated Application Data Store entry being first created.

The Access Data Store has connection into the Active Directory log system to monitor the event log. This connection allows for the Access Data Store to create or remove Users as the event log shows Users entering and exiting the network. This is done asynchronously to the Users access request for Internet resources.

The Access Data Store is referenced by the Internet Control Device to determine a User's credentials prior to allowing access to a specific Internet resource or Application. The Internet Control Device has an existing plethora of methods to restrict access once the User is identified.

### BRIEF DESCRIPTION OF THE DRAWINGS

A more complete understanding of the invention may be obtained from consideration of the following description in conjunction with the drawing, in which:

FIG. 1 shows a user attempting to access an Internet resource through an Internet Control Device;

FIG. 2 shows the state diagram of the access validation process for a single Application;

FIG. 3 shows the data structure for the application, user and computer data store for access and application identification;

FIG. 4 shows application capture extracting the user information from the transfer and identifying the specific application;

### DETAILED DESCRIPTION

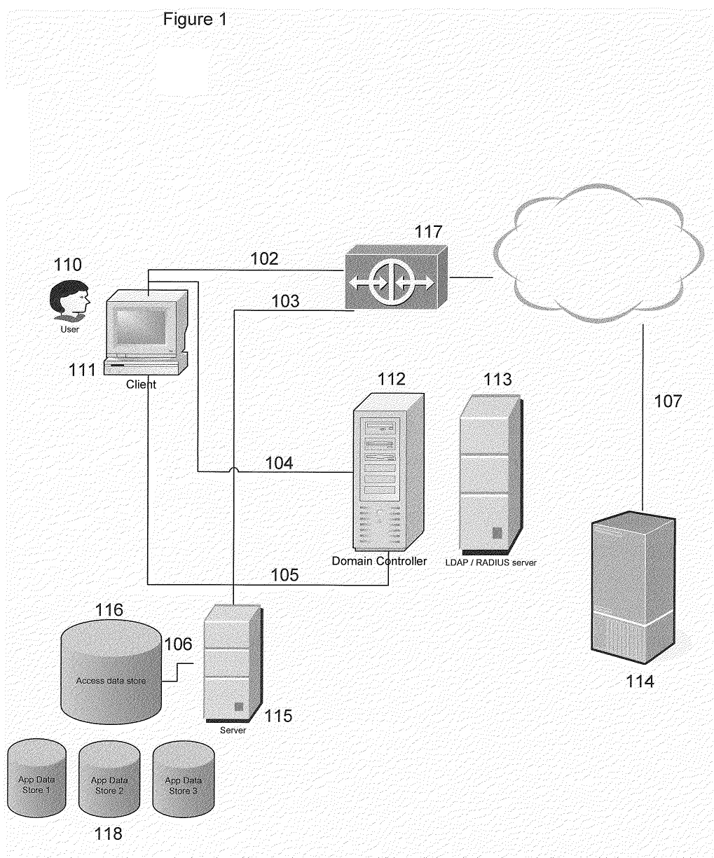

FIG. 1 is a User (110) attempting to access an application from the Internet Resource (114) through a Client (111) via an Internet Control Device (117) through link network link (101). The Internet Control Device (117) quarries the Access Data Store (116) via the Access Control Data server (115) to determine if the User is listed in the Access Data Store (116) database. If the user is not in the Access Data Store (116) then a redirect checker response is sent from the Internet Control Device (117) to the Client (111) via the network link (101) requesting the release of the User's (110) credentials. If the application running on the Client (111) responds to the Authentication request and releases the User's (110) credentials, then the Internet Control Device (117) sends an update to the associated Application Data Store with the User's (110) credentials and the Client (111) information. The Application Data Store (118) updates the Access Data Store (116) with the user's (110) credentials. If the Application fails to respond to the request, the Internet Control Device (117) responds to the Client (111) with a form to input their credentials for the specific application. Once the form for access to that specific application is completed, the Internet Control Device updates the Application Data Store (118) with the Users credentials. Once the credentials are available to the Internet Control Device, the access policy is referenced to determine if the specific User has authorization to access the Internet resource.

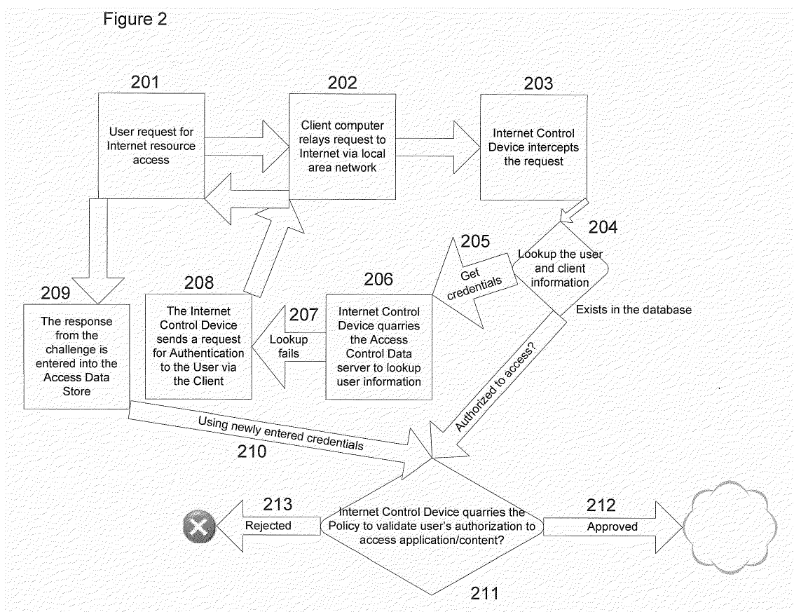

FIG. 2 starts with a request for an Internet application (201) and the client computer (202) converts that request to an IP transaction on the internal network. Once the client sends the request toward the Internet using common routing protocol, the Internet Control Device (203) intercepts the client request and validates that the user's identification for that application is in the Access Data Store (206). If the lookup fails to result in the User's identification (207), the Internet Control Device (208) sends a request for the client's information to the requesting computer (202) and to the user (201). A response for the user (201) is generated and the result is placed into the Application Data Store and then moved into the Access Data Store (209). If the user lookup (204) was successful or the user's credentials (210) were entered, the Internet Control Device (211) policy is inspected to validate that the user can access (212) the specific application on the Internet or if that request is rejected (213).

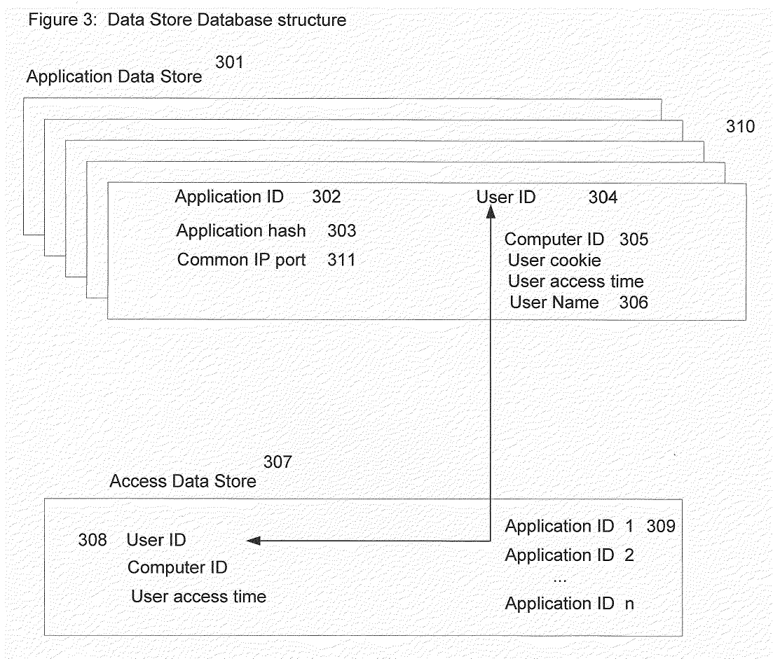

FIG. 3 is the database structure for the two primary data stores used in the art. Data store for Applications (301) is a series of independent database entries, one for each application (310). Within each of these databases is contained the application name and application hash (303) of the first 64K bytes, or less, of the application stream, and the common IP port (311) number assigned to this application. Additionally, within the single application data store exists a list of User IDs (304) using that specific application. The User ID is enhanced by the fields for the Computer ID (305) in which the initial User ID was initiated, a User cookie (305) hash that uniquely identifies a specific user to a specific application on a specific Computer and the common User Name (306) and first use access time for that particular user.

Additionally, the Access Data Store (307) create a database of User IDs (308) which is the same User ID defined in the Application Data Store (304) to allow for an Internet Control Device to isolate a User to an Application. Within the Access Data Store (307) are the Application IDs (309) that specific user accesses as well as the Computer ID and User Access Time.

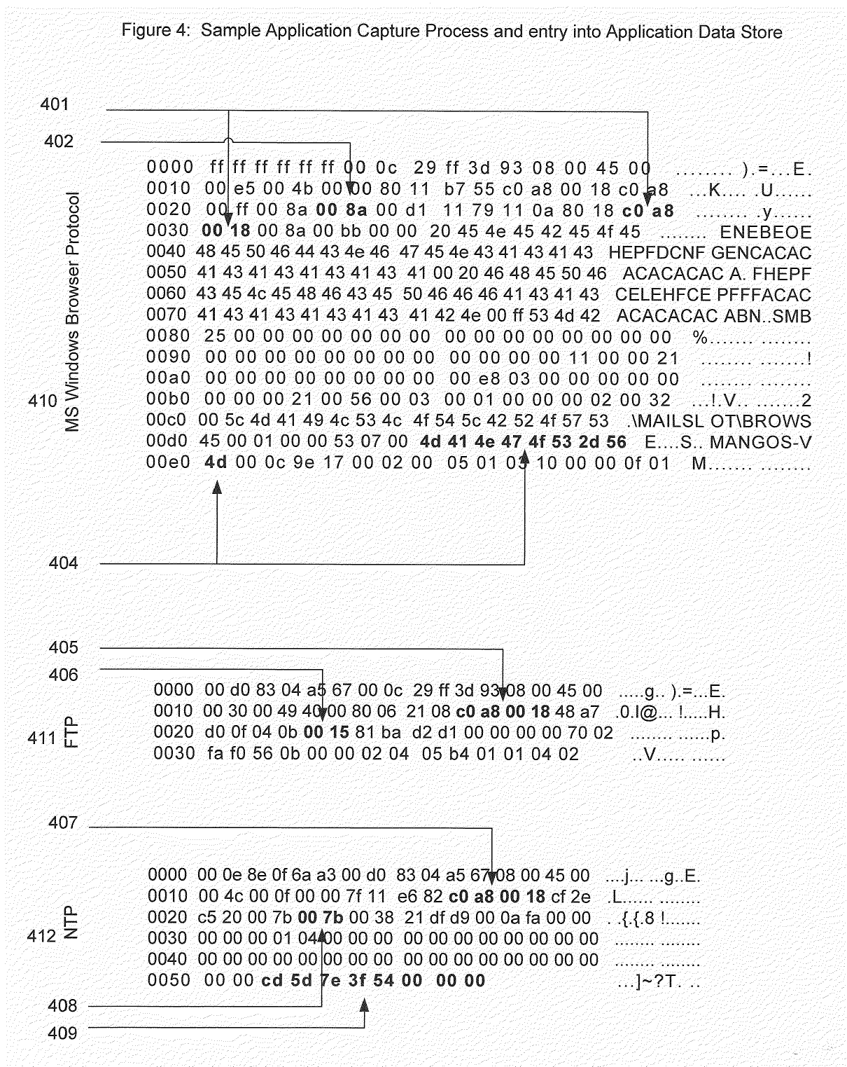

FIG. 4 identifies a sample of application packet captures used to create the Application Data Store and Application Access Store information. Within the capture is the machine identified via the Internet Protocol (IP) address (401, 405, and 407), the specific protocol being captured (402, 406, and 408), the client name using Microsoft Browser Protocol (404), and the time that the machine acquired the Network Time via NTP (409). Using the combination of these items within the Application Data Store, specific user and machine identification is entered into the database (FIG. 3: 301 and 307). This entry of data uniquely tags a user and allows a Network Control Device to create policy around the user's desired access. This sample includes the Network Time Protocol (412), the File Transfer Protocol (411) and the MS Windows Browser Protocol (410).

What is claimed:

1. A method of a client computer system transmitting a request to a server computer system through a plurality of Internet Control Devices

2. A system for containing unique User identification information such as Microsoft® Active Directory, RADIUS, or LDAP infrastructure.

3. A computer implemented method for accessing resources through a communication process over the public Internet

4. The method of claim 3 further comprising:
a. Relaying the request of the resource through a Proxy server device

5. The method of claim 3 further comprising:
a. Restricting the request for the resource through a Firewall device

6. A method to control user access to resource over the public Internet by way of user identification

7. The method of claim 6 further comprising:
a. Replying to the initial request for the unique Internet resource from the client computer using a redirect checker request

8. The method in claim 7 further comprising
a. Client Computer log-in event associated with a specific User action and in response to the User joining the internal network

9. The method of claim 7 further comprising:
a. A specific computer selected reply method determined by the User selected Internet Application Type request

10. The method of claim 7 further comprising:
a. A process to associate the Client Computer environment to the User-Specific information and the Internet Application Type requested.

11. The method in claim 10 further comprising
a. Unencrypted Web (commonly IP port 80) requests use HTTP protocol and WWW-Authenticate Response Header

12. The method in claim 10 further comprising
a. Encrypted Web (commonly IP port 443) request use HTTPS protocol and the WWW-Authenticate Response Header

13. The method of claim 10 further comprising:
a. A Data Store containing the information relating to the User Identification information and the Client Computer Identification information

14. The method of claim 13 further comprising:
a. A timed duration for the expiration of the entry in the data store

15. The method of claim 13 further comprising:
a. A removal of the data entry of a specific User upon that users removal from the internal network resources

16. The method of claim 13 further comprising:
a. Separate Data Stores for each unique Internet Application Type

17. The method of claim 16 further comprising:
a. Seeding unique Data Store information with User information acquired in corresponding Data Store association actions

18. The method of claim 17 further comprising:
a. Aggregation of all unique Data Store information into a central user identification data store associating a specific Client computer to a specific User for a specific Internet Application Type

19. The method of claim 18 further comprising:
a. The limitation of access to the Internet Application resource based on the User identification information collected and policy created on the Internet Control Device
